(19) United States
(12) Patent Application Publication
(10) Pub. No.: US 2009/0013313 A1
(43) Pub. Date: Jan. 8, 2009

(54) DEBUG DEVICE, DEBUG METHOD, AND PROGRAM

(75) Inventors: Koichi Kato, Osaka (JP); Kohsaku Shibata, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/816,321

(22) PCT Filed: Feb. 3, 2006
(86) PCT No.: PCT/JP2006/301839

§ 371 Date: Aug. 15, 2007

(30) Foreign Application Priority Data
Feb. 15, 2005 (JP) 2005-037236

(51) Int. Cl. G06F 9/44

(52) U.S. Cl. 717/129

(57) ABSTRACT

The debug device of the present invention is a debug device which stops execution of a program based on one of a conditional break for stopping the program regardless of the condition of a predicated instruction and an unconditional break for stopping the program only when the condition of the predicated instruction is true. The debug device includes: a receiving unit which receives a breakpoint according to an operation by a user; a determination unit which determines the received break point as the unconditional break or the conditional break; and a stop unit operable to stop the program based on the unconditional break or the conditional break determined by the determination unit.

### TECHNICAL FIELD

The present invention relates to a program debug device for supporting a program development by software developers by arbitrarily starting and stopping a program and displaying an execution state of the program, and relates in particular to a debug device used for a processor that has a predicated instruction.

### BACKGROUND ART

A debug device which pauses execution of a program to be operated on a processor and displays an execution state of the program is very useful for the program development. The program debug device sets a break point in an arbitrary instruction of a program, and pauses the execution of the program. The Patent Reference 1 is a related-art document regarding this feature.

It is disclosed that the interrupt control device (a program debug device) disclosed in Patent Reference 1 has a determination unit which determines whether or not the condition of a predicated instruction is generated, and controls an occurrence of a break interruption based on the determination result. Here, the predicated instruction is an instruction which includes the designation of an execution condition, and which is not executed when the execution condition is not satisfied. Thus, the predicated instruction is executed only when the execution condition is satisfied. Furthermore, one flag value in a status register of a processor is designated as the execution condition. The interrupt control device according to the Patent Reference 1 prevents an occurrence of a break interruption when the execution condition is a predicated instruction whose execution condition is not satisfied even when the instruction matches the break point. As a result, the predicated instruction can control the program so that the program is not to be stopped. Thus, it is possible to prevent a program from being interrupted at an unnecessary point, in a debug operation.

### Patent Reference 1: Japanese Laid-Open Patent Application Publication No. 2001-154877

### DISCLOSURE OF INVENTION

### Problems that Invention is to Solve

According to the above-mentioned prior art, it is necessary to specify, for all break points, whether or not to evaluate an execution condition of an instruction where a break point is to be set, when setting break points. Therefore, without careful attention, the program may not be stopped where a debug operator expects the program to be stopped. Thus, there is a problem that the load on the debug operator increases and the efficiency of the debug operation decreases. For example, an operation of individually specifying, for all break points, whether or not to evaluate an execution condition is required.

Further, in the case where the location of the stopped predicated instruction in the program list is displayed in the debug device, there is a problem that the debug operator cannot immediately determine whether or not the predicated instruction actually specifies the evaluation of the execution condition, or whether or not the predicated instruction is actually stopped because the execution condition is satisfied.

An object of the present invention is to provide a debug device which reduces the load on the debug operator and improves efficiency of the debug operation.

### Means to Solve the Problems

In order to achieve the aforementioned object, the debug device according to the present invention is a debug device which stops execution of a program based on one of an unconditional break for stopping the program regardless of a condition of a predicated instruction and a conditional break for stopping the program only when the condition of the predicated instruction is true, the debug device including: a receiving unit which receives a break point according to an operation by a user; a determination unit which determines the received break point as the unconditional break or the conditional break, according to a state of the debug device, in the case where the breakpoint indicates a predicated instruction; and a stop unit which stops the program based on the unconditional break or the conditional break determined by the determination unit.

Thus, a type of the break point to be set for the predicated instruction (an unconditional break or a conditional break) is determined according to a state of the debug device. Therefore, it is not necessary for the debug operator to individually set, for all break points an unconditional break or a conditional break, reducing the load on the debug operator. Furthermore, the debug operator only needs to recognize whether the break point is the unconditional break or the conditional break according to the state of the debug device. Therefore, it is possible to easily determine whether or not the program is stopped because the execution condition is satisfied. Accordingly, efficiency of debug operations can be improved.

Here, it is also possible that the determination unit judges, as the state of the debug device, whether or not a high-level language source code display window is focused on when the receiving unit receives the break point

Here, it is also possible that the determination unit: determines the break point as the conditional break upon judging that the source code display window is focused on; and determines the break point as the unconditional break upon judging that the source code display window is not focused on.

Thus, in the case where the debug operator focuses on the source code display window, the break point is a conditional break of suitable for debugging at the source program level, thus improving efficiency of the debug operation. On the other hand, in the case where the debug operator does not focus on the source code display window, for example, in the case where the debug operator focuses on an assembly code display window, the break point is an unconditional break suitable for debugging at the assembly program level, thus improving efficiency of the debug operations.

Here, it is also possible that the determination unit judges, as the state of the debug device, whether or not a source code is displayed on a high-level language source code display window, when the receiving unit receives the break point.

Thus, the type of the break point is set by determining whether or not the source code is displayed, reducing the load of setting the type on the debug operator.

Here, it is also possible that the determination unit: determines the break point as the conditional break upon judging that the source code is displayed on the source code display window; and determines the break point as the unconditional break upon judging that the source code is not displayed on the source code window.

Thus, in the case where the source code is displayed, the break point is the conditional break suitable for debugging at the source program level, thus improving efficiency of the debug operation. On the other hand, in the case where the source code is not displayed, for example, in the case where an assembly code is displayed, the break point is an unconditional break suitable for debugging at the assembly program level, thus improving efficiency of the debug operations.

Here, it is also possible that the determination unit judges, as the state of the debug device, whether or not a source code line is designated in a high-level language source code display window, when the receiving unit receives the break point.

Thus, the state of the debug device is set by determining whether or not a source code is specified. Therefore, the load of individually setting the type of a break point on the debug operator can be reduced.

Here, it is also possible that the determination unit: determines the break point as the conditional break upon judging that the source code line is designated in the source code display window; and determines the break point as the unconditional break upon judging that the source code line is not designated in the source code display window.

Thus, in the case where the debug operator focuses on a source code, the break point is a conditional break suitable for debugging at the source program level, thus improving efficiency of the debug operation. On the other hand, in the case where the debug operator does not focus on a source code, for example, in the case where the debug operator focuses on an assembly code, the break point is an unconditional break suitable for debugging at the assembly program level, thus improving efficiency of the debug operations.

Here, it is also possible that the determination unit judges, as the state of the debug device, whether or not a high-level language source code display window is focused on, during the execution of the program.

Thus, the type of the break point can be changed without stopping the execution of the program, according to the state of the debug device during program execution. Therefore, it is possible to reduce the load, on the debug operator, of individually setting the type of the break point.

Here, it is also possible that the determination unit: determines the break point as the conditional break upon judging that the source code display window is focused on; and determines the break point as the unconditional break upon judging that the source code display window is not focused on.

Here, it is also possible that the debug device, further includes an attaching unit which attaches a mark to a source code line or an assembler code line that is designated as the break point, the mark indicating a break point, and the mark is different depending on whether the break point is the unconditional break or the conditional break.

According to the aforementioned configuration, the debug operator can visually understand the type of the break point and omit the operation of verifying the type of the break point, thus reducing processing load on the debug operator and improving the efficiency in debug operations.

Furthermore, a debug method and a program thereof of the present invention have an operational effect which is the same as that of the debug device.

### EFFECTS OF THE INVENTION

According to the debug device of the present invention, it is not necessary for the debug operator to individually set one of an unconditional break and a conditional break, resulting in a reduction of the load on the debug operator. Furthermore, it is possible to easily determine whether or not a program is stopped because the execution condition is satisfied, by merely determining the state of the debug device. Consequently, efficiency of debug operations can be improved.

### BRIEF DESCRIPTION OF DRAWINGS

FIG. 1 is a diagram showing an external view of a program debug system 1 according to the first embodiment of the present invention.

FIG. 2 is a diagram showing an external view of a program debug system 5.

FIG. 3 is a block diagram showing a functional configuration of a main device 2a.

FIG. 4 is a diagram showing an example of display contents displayed during the execution of debug software in the program debug device 2.

FIG. 5 is a diagram showing an example of converting source codes of a program to be debugged.

FIG. 6 is a diagram showing a display example of an instruction line.

FIG. 7 is a flowchart showing details of break point set processing step S1.

FIG. 8 is a flowchart showing details of window focus processing step S21.

FIG. 9 is a flowchart showing details of break mode flag set processing step S11.

FIG. 10 is a flowchart showing details of source code display processing step S22 according to the second embodiment of the present invention.

FIG. 11 is a flowchart showing details of break mode flag set processing step S13.

FIG. 12 is a flowchart showing details of break point set processing step S1a according to the third embodiment of the present invention.

FIG. 13 is a flowchart showing details of break mode flag set processing step S12.

FIG. 14 shows automatically determining a type of a break according to a state in which the break is set.

FIG. 15 is a flowchart showing details of break processing step S2 according to the fourth embodiment of the present invention.

FIG. 16 is a flowchart showing details of break point set processing step S1b according to the fifth embodiment of the present invention.

FIG. 17 is a flowchart showing details of mode flag set processing step S31.

FIG. 18 is a flowchart showing details of break point display processing step S32.

FIG. 19 is a flowchart showing details of break point display processing step S33 according to the sixth embodiment of the present invention.

FIG. 20 is a diagram showing a display example of a source display window and an assembly display window.

### NUMERICAL REFERENCES

1 Program debug system
2 Program debug device
2a Main device
2b Display device
2c Input device
3 Program execution device
3a Main device
3b Display device
3c Input device
4 LAN cable
5 Program debug system
6 Program execution device
7 Connection cable
10 C language source code
11 Assembly language code
21 Receiving unit
22 State determination unit 22
22a Break mode flag
23 Break point set unit
24 Interface unit
25 Display control unit
26 Control unit

### BEST MODE FOR CARRYING OUT THE INVENTION

Hereinafter, preferred embodiments for implementing the present invention are described with reference to drawings.

### First Embodiment

<External View of Program Debug System>

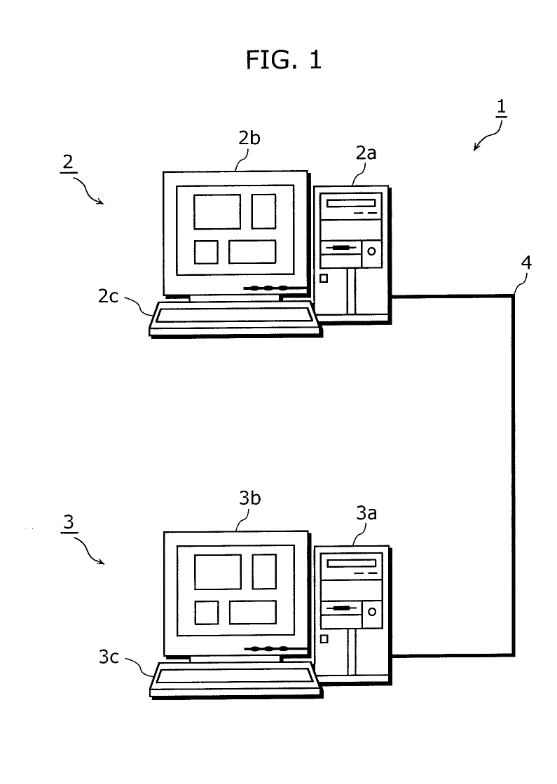

FIG. 1 is a diagram showing an external view of a program debug system according to the first embodiment of the present invention. The program debug system 1 in this diagram includes a program debug device 2 and a program execution device 3. The program debug device 2 includes a main device 2a, a display device 2b, and an input device 2c. The main device 2a receives various operational instructions from a debug operator via the input device 2c, controls the program execution device 3 for an execution of a program to be debugged, and causes the display device 2b to display the execution state.

The break for executing the program to be debugged by the program debug device 2 has two types of an unconditional break and a conditional break, in the case where a break point is set in the predicated instruction. Here, the predicated instruction is an instruction which includes a designation of an execution condition, and is an instruction which is not executed when the execution-condition is not satisfied, and executed only when the execution-condition is satisfied. Then, one flag value in a status register included in a processor is designated as the execution condition. “Unconditional break” indicates that execution of a program is stopped with the predicated instruction having an execution condition which is not satisfied. In other words, unconditional break is a break point at which the execution of a program is stopped regardless of a condition attached to the predicated instruction. “Conditional break” indicates that the execution of a program is not stopped with the predicated instruction having an execution condition which is not satisfied but is stopped with the predicated instruction having an execution condition which is satisfied. In other words, conditional break is a break point at which the program is stopped only when the condition attached to the predicated instruction is true. Furthermore, a predicated instruction having an execution condition which is not satisfied is called a pass instruction.

The program debug device 2 determines whether the break point is determined as an unconditional break or a conditional break depending on a state of the debug device, when the break point indicates an predicated instruction.

The program execution device 3, which includes a main device 3a, a display device 3b, and an input device 3c, is a data processing device which executes simulation software that imitates an operation of a processor (or an evaluation board including the processor) for executing the program to be debugged. The program execution device 3 can be an alternative when there is no target system yet at the time of designing.

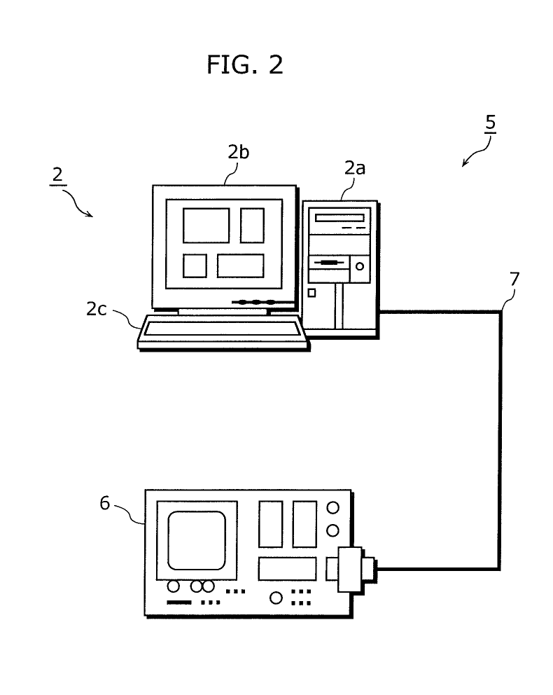

FIG. 2 is a diagram showing an external view of another program debug system 5. The program debug system 5 in FIG. 2 is different from the program debug system in FIG. 1 in that it includes a program execution device 6 in place of the program execution device 3. The program execution device 6 is a processor or an evaluation board including a processor, and is controlled by the program debug device 2 through a connection cable 7.

The program debug device 2 operates substantially in a same manner in the case of being connected to the program execution device 3 that is a simulator as shown in FIG. 1 and in the case of being connected to the program execution device 6 that is a processor (or an evaluation board) as shown in FIG. 2. Furthermore, the computer of the program debug device 2 may also execute the simulation software so as to be used also as the program execution device 3.

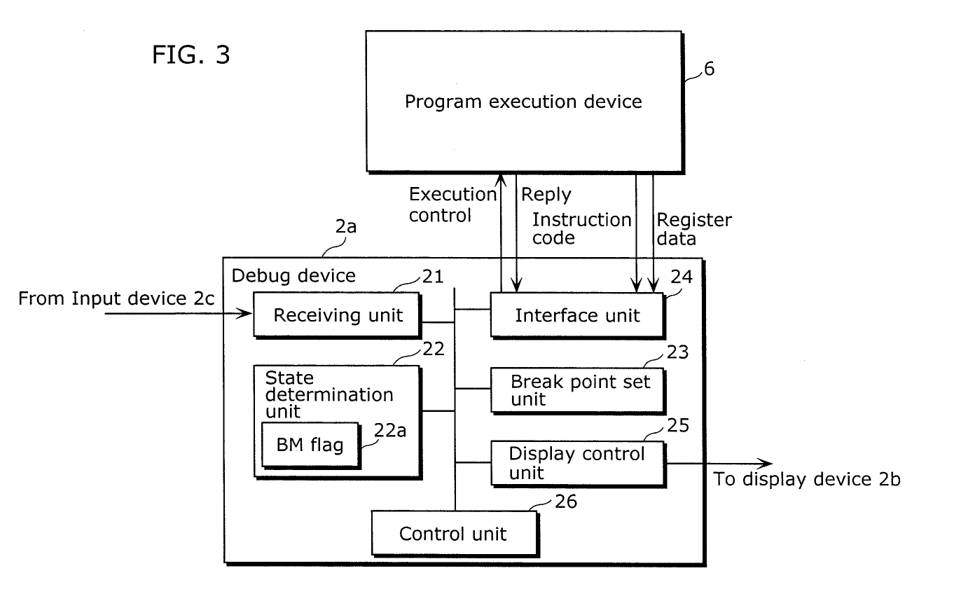

FIG. 3 is a block diagram showing a functional configuration of the main unit 2a. As shown in FIG. 3, the main unit 2a includes a receiving unit 21, a state determination unit 22, a break point set unit 23, an interface unit 24, a display control unit 25, and a control unit 26. The state determination unit 22 internally holds a break mode flag 22a.

The receiving unit 21 receives a break point set operation from the input device 2c in accordance with the operation by the user. The break point set operation designates, as a break point, one of a source code line, mnemonic code line, and an address that is arbitrarily selected by the user.

The state determination unit 22 determines a state of the program debug device 2 when the receiving unit 21 receives an operation of setting a break point, and sets a value of a break mode flag (BM flag in the diagram), which is internally held in the state determination unit 22, in accordance with the determined state. Here, the state is a state displayed, for example, on the display device 2b, and indicates whether or not a high-level language source code display window is focused on.

The break point set unit 23 determines the received break point as an unconditional break or a conditional break in accordance with the state of the program debug device 2 determined by the state determination unit 22, when the break point received by the receiving unit 21 is a predicated instruction.

The interface unit 24 outputs an execution control signal to the program execution device 6, and receives a response signal, an instruction code, and register data from the program execution device 6.

The display control unit 25 generates display data for each window, and controls a display of the display device 2b. The control unit 26 controls an entirety of the main device 2a.

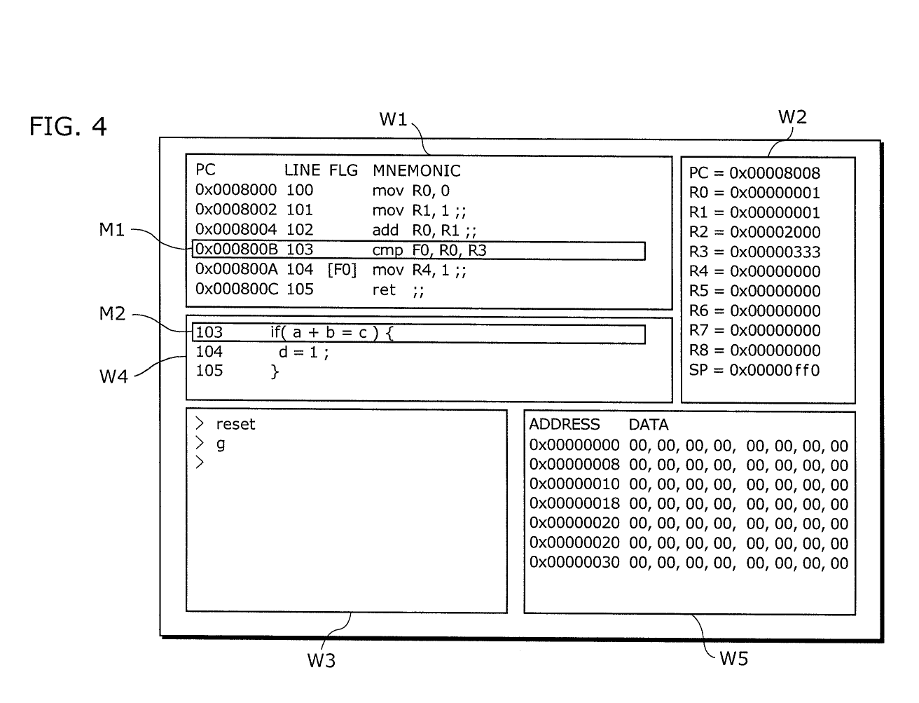

FIG. 4 shows an example of display contents during the execution of debug software in the program debug device 2. In FIG. 4, W1 is a code display window for displaying instruction codes of the program to be debugged; W2 is a source display window for displaying a source program to be debugged; W3 is an instruction input window for inputting an instruction for each simulation by a user's operation; W4 is a register details display window for displaying register data; and W5 is a memory contents display window for displaying memory data.

M1 is a stop instruction mark which indicates an unexecuted first instruction in the program to be debugged whose execution is currently being stopped (hereinafter referred to as a stop instruction), and M2 is a stop line mark which indicates a source code line in the source program corresponding to the stop instruction.

The code display window W1 displays a program counter value (PC column in FIG. 4) which indicates an instruction address of the program to be debugged, a line number (LINE column), a flag (FLG column), a mnemonic (MNEMONIC column), and the like, as well as a stop instruction mark M1. In FIG. 4, the instruction ([F]mov R3, 1) at the 104-th line and the instruction ([F]mov R0, 5) at the 105-th line are the predicated instructions. Here, flag [F] indicates a value of a flag F in the state flag register included in the processor for executing the program to be debugged, and is a condition of the predicated instruction. In the example of the program shown in FIG. 4, the flag F is set or reset based on a comparison result by the comparison instruction (cmp instruction) immediately before (103-th line) of the condition attached execution instruction. The predicated instructions at the 104-th and 105-th lines are executed only when the flag F is set. Thus, the flag F is used, for example, for an execution statement and the like depending on a condition determined by “if” statement at the 103-th line displayed on the source display window W2, by reflecting, to the value of the flag F, the determination result of whether or not the condition for the conditional branching is satisfied. Furthermore, when the instruction is executed only in the case where the flag F is reset, [!F] is displayed in place of [F].

<Program to be Debugged According to the First Embodiment>

The program to be debugged can be written in C language. The C language compiler converts the program written in C language into an assembly language which corresponds, approximately on a one-to-one basis, to a machine language which can be interpreted by the processor. Furthermore, the assembly language is further converted, by an assembler and a linker, into a machine language which can be executed by a processor.

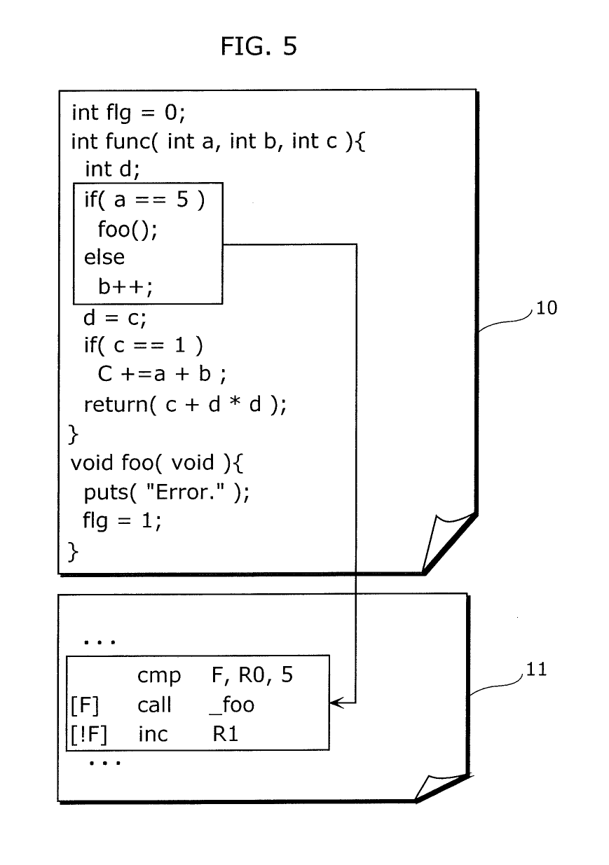

FIG. 5 is an example showing how a part of the C language source code 10 is converted into the assembly language code 11 by the C language compiler.

The execution statement of the C language source code 10 which depends on the “if” statement indicated in an area enclosed by the dotted line in the C language source code 10 and a condition thereof correspond to an area enclosed by the dotted line in the assembly language code 11. As described above, the determination result of whether or not the condition for the condition branching is satisfied is reflected to the value of the flag F. Accordingly, a branch instruction is removed from the assembly language code 11, preventing the performance from being degraded by a branch caused when the processor executes a program.

In the assembly language code 11, the instruction to which [F] is attached is a code corresponding to an execution statement following “then” in the “if” statement, while the instruction to which [!F] is attached is a code corresponding to an execution statement following “else” in the “if” statement.

The program to be debugged includes, as a part of the source code, a C language source code 10 and the like. Here, the source code is converted into an execution formatted file, which is executable by the program execution device 3 or the program execution device 6, using a compiler, an assembler, and a linker.

The execution formatted file and the C language source code are inputted to the program debug device 3. The execution formatted file is executed by one of the program execution devices 3 and 6. The debug operator performs debug operation while controlling execution of a program by one of the program execution devices 2 and 6, via the program debug device 3.

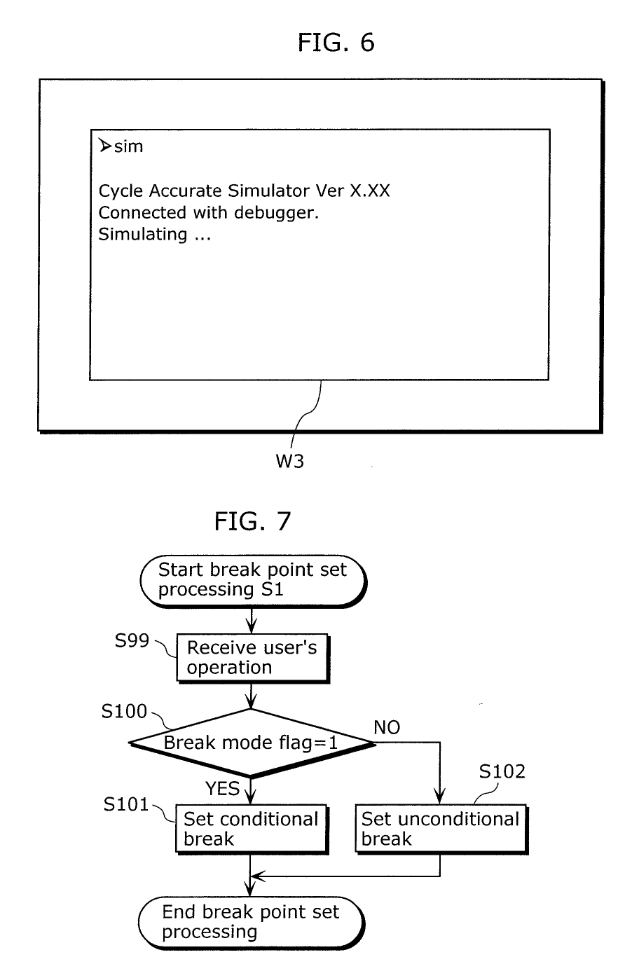

FIG. 6 is a diagram showing a display example of an instruction line displayed on the instruction input window W3. In FIG. 6, “sim” is an instruction which instructs to start simulating the program execution by one of the program execution devices 3 and 6. The debug operator further performs debug operation by inputting instructions for an operation of setting a break point, an operation of executing (simulation) a program to be debugged, an operation of register data, an operation of memory data, and so on.

<Break Point Set Processing in the First Embodiment>

First, a break point set processing (S1) which is a unique process of the present invention in the first embodiment shall be described.

FIG. 7 is a flowchart showing details of the break point set processing S1 for setting a break point based on the control by the control unit 26. As shown in FIG. 7, the control unit 26 performs the following steps: a receiving step S99 of receiving a break point according to a user's operation; a break mode flag determination step S100 of determining a break mode flag for changing a setting between the unconditional break and the conditional break; a step S101 of setting the conditional break when it is determined that the break mode flag is 1 in the break mode flag determination step S100; and a step S102 of setting the unconditional break when it is determined that the break mode flag is other than 1 in the break mode flag determination step S100, and terminates the break point set processing.

Here, an initial value of the break mode flag may be either 0 or 1. Note that, the initial value may be determined based on whether or not there is a source file.

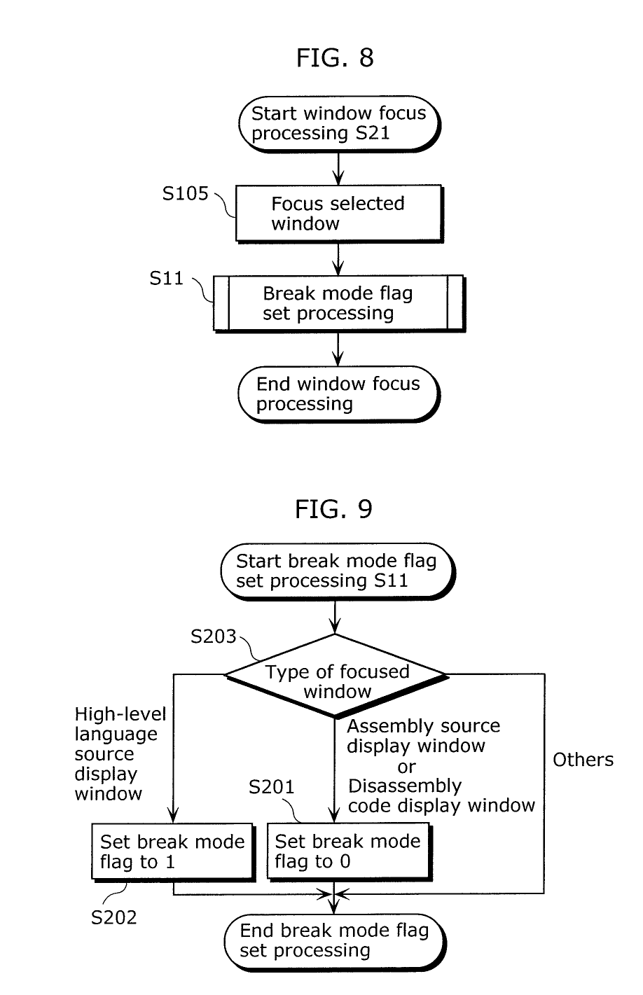

FIG. 8 is a flowchart showing details of the window focus processing S21 performed when a window, on which the program to be debugged is displayed, is focused on by the program debug device 2. In FIG. 8, the control unit 26 performs a step S105 of focusing on a selected window, and a break mode flag set processing step S11 of setting a break mode flag by determining which window is focused on, and then terminates the window focus processing.

FIG. 9 is a flowchart showing details of the break mode flag set processing step S11. As shown in FIG. 9, the control unit 26 performs the following steps: a source focus determination step S203 of determining whether or not the high-level language source display window is focused on by the display device 2b of the program debug device 2; a step S202 of setting the break mode flag to 1 in the case where it is determined that the high-level language source display window is focused on in the source focus determination step S203; a step S201 of setting the break mode flag to 0 in the case where it is determined that the assembly language source display window is focused on or that the disassembly language source display window is focused on; and a step of not performing processing of the break mode flag in the case where a window other than the aforementioned windows is focused on in the source focus determination step S203, and then terminates the break mode flag set processing.

Next, an example of the break point set processing S1 shall be described. When the high-level language source display window is focused on according to a click operation by the debug operator of clicking the source display window, the window focus processing step S21 is performed, and the step S105 of focusing on the selected window and the break mode flag set processing step S11 are then performed. The break mode flag is set to 1 because the process to be performed when the high-level language source display window is focused on is selected in the source focus determination step S203 within the break mode flag set processing step S11. In this state, when the break point set processing S1 is performed, the process of setting the break mode flag value to 1 is selected in the break mode flag determination step S100, a conditional break is set at the designated portion in the step S101 of setting a conditional break. Then when the program is executed, since the conditional break has been set, the program is stopped only when the condition attached to the predicated instruction is true. Furthermore, even when the program is executed after the disassembly code display window is focused on according to the click operation by the debug operator, since the set break point is a conditional break, the program is stopped only when the condition of the predicated instruction is true.

Furthermore, when the disassembly code display window is focused on according to the click operation by the debug operator, the window focus processing S21 is performed, and the step S105 of focusing on the selected window and the break mode flag set processing step S11 are then performed. The break mode flag is set to 0 because the process to be performed when the disassembly code display window is focused on is selected in the source focus determination step S203 within the break mode flag set processing step S11. In this state, when the break point set processing S1 is performed, the process of setting the break mode flag value to 0 is selected in the break mode flag determination step S100, an unconditional break is set at the designated portion in the step S102 of setting the unconditional break. When the program is executed, the program is stopped regardless of the condition attached to the predicated instruction. The conditional break set after the high-level language source display window is focused on serves as the conditional break until the conditional break is dissolved, while the unconditional break set after the disassembly code display window is focused on serves as the unconditional break until the unconditional break is dissolved.

According to the aforementioned configuration, an appropriate break point for a source code and the like that has thus far been focused on by the debug operator can be automatically used, thus improving efficiency in debug operations.

### Second Embodiment

The external view of the program debug system, the display contents displayed by the display device 2b, and the program to be debugged according to the second embodiment are approximately the same as the external view, display contents, and the program to be debugged in the first embodiment. Hereinafter, detailed descriptions about the elements which are the same shall be omitted, and description shall be centered on the points of difference.

<Program to be Debugged According to the Second Embodiment>

The program debug system in the second embodiment of the present invention is the same as the program to be debugged in the first embodiment of the present invention, and therefore detailed description thereof shall be omitted.

<Structure of a Break Point Set Processing in the Second Embodiment>

First, a variation of the break point set processing (S1) which is a unique process in the second embodiment of the present invention shall be described. Specifically, whereas in the break point set processing S1 in the first embodiment of the present invention, the window focus processing S21 is performed as a process of changing a break mode flag, the process S22 of displaying the program to be debugged is performed by the program debug device 2 in the present embodiment.

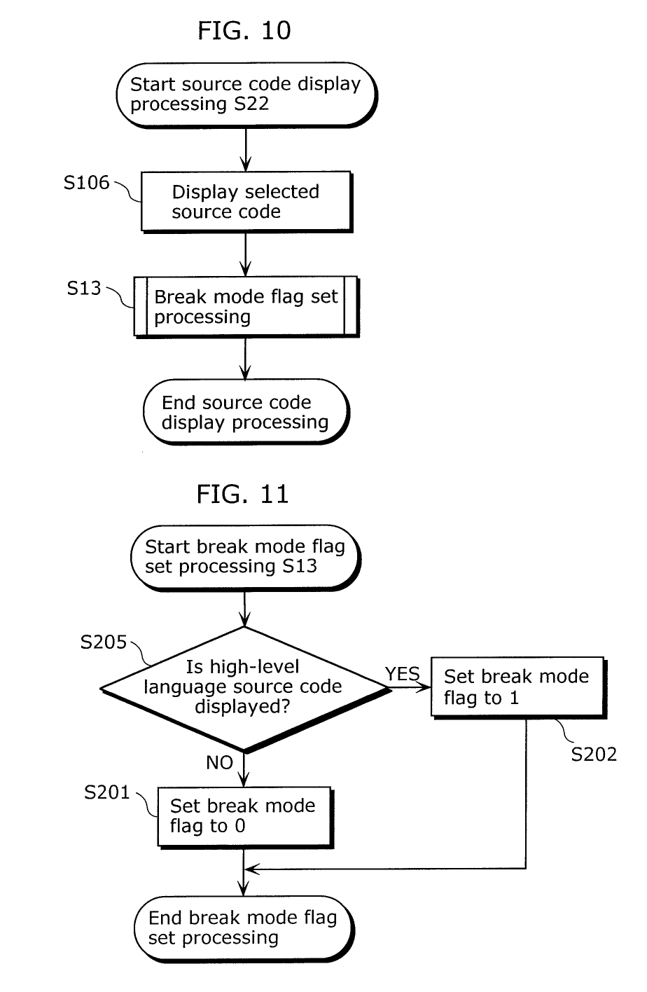

FIG. 10 is a flowchart showing details of the source code display processing S22 performed by the display control unit 26 for displaying the program to be debugged in the program debug device 2. In FIG. 10, the control unit 26 performs the step S106 of displaying the selected source code and the break mode flag set processing S13 of determining the displayed source code and setting its break mode flag, and then terminates the source code display processing.

FIG. 11 is a flowchart showing details of the break mode flag set processing step S13. As shown in FIG. 11, the control unit 26 performs the following steps: a source display determination step S206 of determining whether or not the source code written in the high-level language is displayed on the display device 2b of the program debug device 2; and a step S202 of setting the break mode flag to 1 in the case where it is determined that the source code written in the high-level language is displayed in the source display determination step S206, or the step S201 of setting the break mode flag to 0 in the case where it is determined that the source code written in the high-level language has not been displayed in the source display determination step S206, and then terminates the break mode flag set processing.

Next, an example of a variation of the break point set processing S1 shall be described. When a source code line is selected and the break point is designated according to the user's operation, the source code display processing S22 is performed, and the process S106 of displaying the selected source code and the break mode flag set processing step S13 are then performed. The break mode flag is set to 1 because the process to be performed when the source code written in the high-level language is focused on is selected in the source display determination step S205 in the break mode flag set processing step S13. Since the break point set processing 1 is the same as that of the first embodiment, detailed description thereof shall be omitted.

According to the aforementioned configuration, it is possible for the debug operator to predict the program to be debugged, and automatically use the appropriate break point, thus improving efficiency in debug operations.

### Third Embodiment

The external view of the program debug system, the display contents by the display device 2b, and the program to be debugged according to the third embodiment of the present invention are approximately as the external view, display contents, and the program to be debugged in the first embodiment. Hereinafter, detailed descriptions about the elements which are the same shall be omitted, and description shall be centered on the points of differences.

<Program to be Debugged According to the Third Embodiment>

The program debug system in the third embodiment of the present invention is the same as the program to be debugged in the first embodiment of the present invention, and therefore detailed description thereof shall be omitted.

<Structure of a Break Point Set Processing in the Third Embodiment>

The break point set processing S1a which is a unique process in the third embodiment of the present invention shall be described.

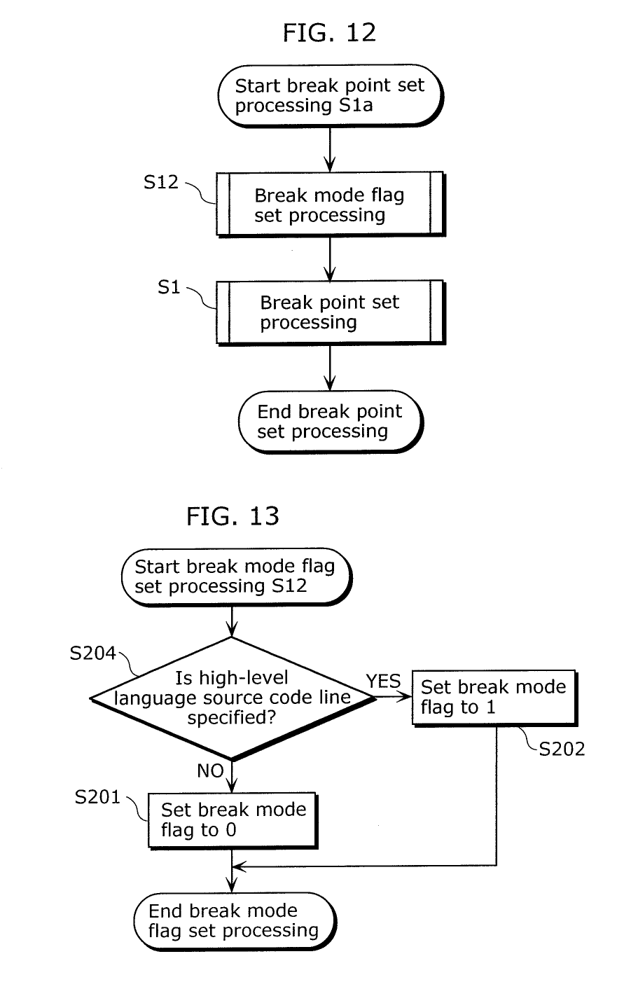

FIG. 12 is a flowchart showing details of the break point set processing S1a performed by the control unit 26 for setting a break point to debug the program to be debugged by the program debug device 2. As shown in FIG. 12, the control unit 26 performs the following steps: a break mode flag set processing step S12 of determining a location of the break point designated by the user's operation and setting a break mode flag; and the break point set processing step S1, and then terminates the break point set process.

FIG. 13 is a flowchart showing details of the break mode flag set processing step S12. In FIG. 13, in the break mode flag set processing S12, a source code determination step S204 of determining whether or not a source code line written in a high level language is designated as a designated break point in the program debug device 2 is performed, and a step S202 of setting the break mode flag to 1 in the case where it is determined that the source code line written in the high level language is designated in the source code determination step S204 or a step S201 of setting the break mode flag to 0 in the case where it is determined that the source code line written in the high level language is not designated in the source code determination step S204 is performed. After these steps, the break mode flag set processing is terminated.

According to the aforementioned configuration, an appropriate break point can be automatically used by determining a point to be focused on next from the break point set by the debug operator, thus improving efficiency in debug operations.

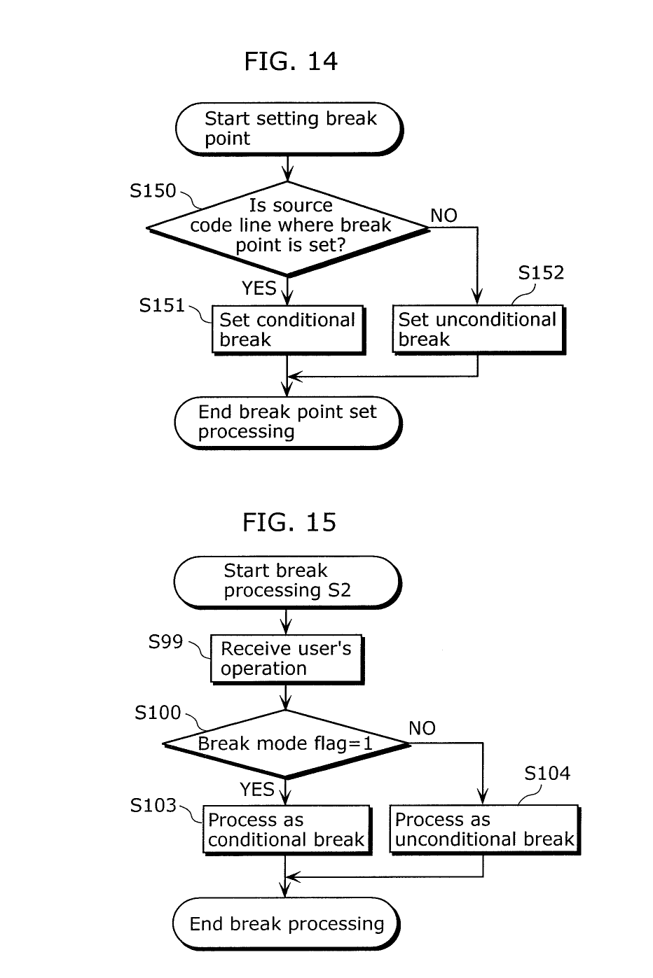

Here, the break point set processing as shown in FIG. 14 may be performed without using the break mode flag, instead of performing the break point set processing as shown in FIG. 12 and FIG. 13. Specifically, the control unit 25 performs the following steps: a step S150 of determining whether or not the break point designated by the user's operation is the source code line; a step S151 of processing the break mode flag as a conditional break when it is determined that the break mode flag is 1 in the break mode flag determination step S100; and a step S152 of processing the break mode flag as un conditional break when it is determined that the break mode flag is other than 1 in the break mode flag determination step S301, and then terminates the break process.

### Fourth Embodiment

The external view of the program debug system, the display contents displayed by the display device 2b, and the program to be debugged according to the fourth embodiment of the present invention are approximately the same as the external view, display contents, and the program to be debugged in the first embodiment. Hereinafter, detailed descriptions about the elements which are the same shall be omitted, and description shall be centered on the points of difference.

<Structure of a Break Processing According to the Fourth Embodiment>

The break processing S2 which is a unique process in the fourth embodiment of the present invention shall be described.

FIG. 15 is a flowchart showing details of the break processing S2 performed by the control unit 26 when the program to be debugged is stopped at the break point during the debugging of the program to be debugged in the program debug device 2. As shown in FIG. 15, the control unit 26 performs the following steps: a receiving step S99 of receiving a break point according to a user's operation; a break mode flag determination step S100 of determining a break mode flag; a step S103 of processing the break mode flag as the conditional break when it is determined that the break mode flag is 1 in the break mode flag determination step S100; and a step S104 of processing the break mode flag as the unconditional break when it is determined that the break mode flag is other than 1 in the break mode flag determination step S301, and then terminates the break processing.

Here, an initial value of the break mode flag may be either 0 or 1. Then, the break mode flag may be changed in the window focus processing S21 according to the first embodiment of the present invention or in the source code display processing S22 according to the second embodiment of the present invention.

Next, an example of the break processing S2 shall be described. Here, when the program to be debugged is debugged, it is assumed that the break mode flag may be changed in the window focus processing S21 according to the first embodiment of the present invention. When the high-level language source display window is focused on, the window focus processing S21 is performed, and then the step S105 of focusing on the selected window and the break mode flag set processing step S11 are performed. The break mode flag is set to 1 because the process for the high-level language source display window which is focused on is selected in the source focus determination step S203 within the break mode flag set processing step S11. In this state, a break point is set for the program to be debugged, and the program is executed. When the program is stopped at the break point and the break processing S2 is performed, since the process for the case where the value of the break mode flag is 1 is selected in the break mode flag determination step S100, the break mode flag is processed as a conditional break.

When the disassembly code display window is focused on, the window focus processing S21 is performed, and then the step S105 of focusing on the selected window and the break mode flag set processing step S11 are performed. The break mode flag is set to 0 because the process for the disassembly code display window which is focused on is selected in the source focus determination step S203 within the break mode flag set processing step S11. When the program is executed in this state, if the program is stopped at the break point and the break processing S2 is performed, since the process to be performed for the case where the value of the break mode flag is 0 is selected in the break mode flag determination step S100, the break mode flag is processed as a conditional break. At the set break point, the value of a break mode flag is changed between the source display window focus or the code display window focus, and the operation of the break processing is also changed accordingly.

According to this structure, when the debug operator performs debug operation focusing on the source code written in the high-level language, the program is stopped at the source code line, at which the break point is set, only when the condition attached to the predicated instruction is satisfied, and when the debug operator performs debug operation focusing on the source code written in the disassembly language or the like, an appropriate break point can be automatically used so as to stop the program regardless of the condition set in the condition attached instruction. Therefore, efficiency in debug operations can be improved.

### Fifth Embodiment

The program to be debugged according to the fifth embodiment of the present invention is the same as the program to be debugged in the first embodiment of the present invention, and therefore the detailed description of the elements which are the same shall be omitted. In the fifth embodiment, the program debug device holds, for each break point, a mode flag indicating a type of a break point which is either a conditional break or an unconditional break.

<Structure of a Break Point Display Processing According to the Fifth Embodiment>

The break point display processing S32 which is a unique process in the fifth embodiment of the present invention shall be described.

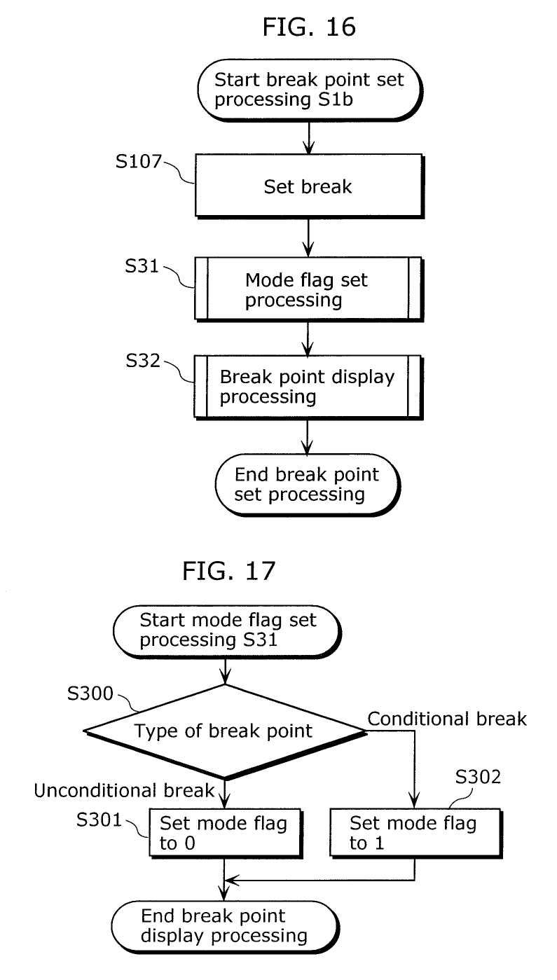

FIG. 16 is a flowchart showing details of the break point set processing S1b for setting a break point so that the program debug device 2 debugs the program to be debugged. As shown in FIG. 16, the control unit 26 performs the following steps: a step S107 of setting a break point; a mode flag set processing step S31 of setting a mode flag depending on the set break type; and a break point display processing S32 of determining a value of the mode flag and displaying a mark at the break point, and then terminates the break point setting process.

FIG. 17 is a flowchart showing details of the mode flag set processing S31. In FIG. 17, in the mode flag set processing S31, the following steps are performed: the break determination step S300 of determining the set break type; the step S302 of setting and holding the mode flag as 1 so as to correspond to the break point when it is determined that the conditional break is set for the break point in the break determination step S300; and the step S301 of setting and holding the mode flag as 0 so as to correspond to the break point when it is determined that the unconditional break is set in the break determination step S300. Then the mode flag set processing is terminated.

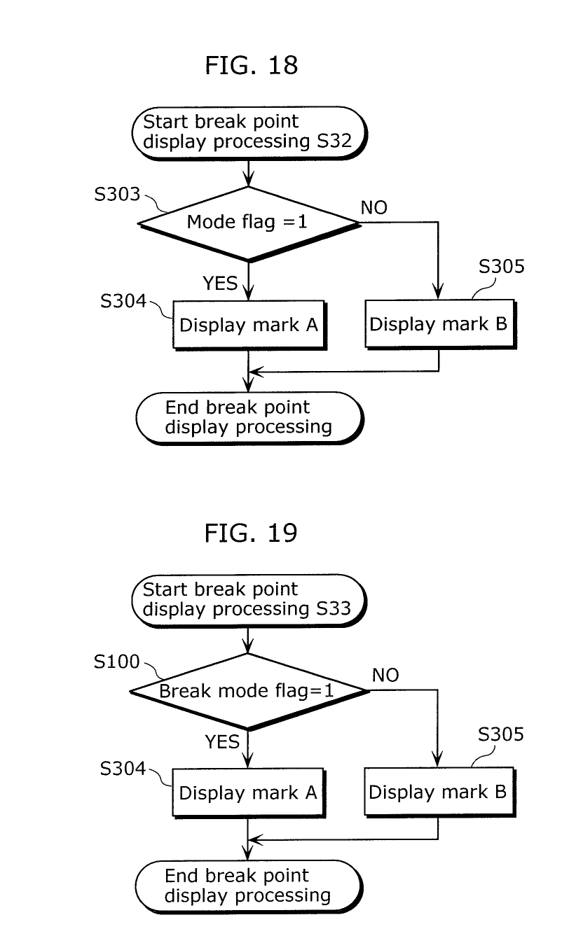

FIG. 18 is a flowchart showing details of break point display processing step S32. In FIG. 18, in the break point display processing S32, the following steps are performed: the mode flag determination step S303 of determining whether a mode flag indicates the unconditional break or the conditional break as being set for the break point; a step S304 of displaying a mark A at the set break point when it is determined that the mode flag is 1 in the mode flag determination step S303; and a step S305 of displaying a mark B at the set break point when it is determined that the mode flag is 0 in the mode flag determination step S303. Then the break point display processing is terminated.

Next, an example of the break point display processing S32 shall be described. When the program debug device 2 performs the break point set processing S1b on the source code written in high-level language, if a break point is set by the break point set processing according to the third embodiment of the present invention, a conditional break is set for the designated source code line in the break set step S107. The mode flag is set to 1 because the process to be performed for the conditional break which is set is selected in the break determination step S300 within the break mode set processing step S31. When the break point display processing step S32 is performed in this state, since the mode flag is 1 in the mode flag determination step S303, the mark A is displayed at the break point.

When the break point set processing S1b is performed on a disassembly language, an unconditional break is set in the break set step S107, and the mode flag is set to 0 because the process to be performed for the unconditional break which is set is selected in the break determination step S300 within the mode flag set processing step S31. When the break point display processing step S32 is performed in this state, since the mode flag is 0 in the mode flag determination step S303, the mark B is displayed at the set break point.

According to the aforementioned configuration, the debug operator can visually recognize the type of the break point and omit the operation of verifying the type of the break point, thus reducing processing loads on the debug operator and improving efficiency in debug operations.

Whereas in the present embodiment, marks A and B are used for distinguishing the break points, other alphabets such as C and D, numeric such as 1 and 2, symbols such as □ and □, or the like may be similarly used.

Whereas in the present embodiment, marks A and B are used for distinguishing the break points, the marking may be replaced by coloring the background of the source code line at which the break point is set with colors such as blue and red, adding lines such as wave lines and straight lines above and below the source code line at which the break point is set, enclosing the source code line at which the break point is set with various boxes of different widths, or the like.

### Sixth Embodiment

<External View of the Program Debug System According to the Sixth Embodiment>

The external view of the program debug system according to the sixth embodiment of the present invention is the same as the program debug system in the first embodiment, and therefore detailed description about the same external view is omitted.

The contents displayed on the screen of the program debug device is the same as those displayed on the screen according to the first embodiment, and therefore detailed description about the same contents is omitted.

<Program to be Debugged According to the Sixth Embodiment>

The program to be debugged according to the sixth embodiment of the present invention is the same as the program to be debugged in the first embodiment of the present invention, and therefore detailed description thereof shall be omitted.

<Structure of a Break Point Display Processing According to the Sixth Embodiment>

The break point display processing S33 which is a unique processing in the sixth embodiment of the present invention shall be described.

FIG. 19 is a flowchart showing details of the break point display processing S33 performed by the control unit 26. As shown in FIG. 19, the control unit 26 performs the following steps: a break mode flag determination step S100 of determining a break mode flag; a step S304 of displaying a mark A at the break point when it is determined that the break mode flag is 1 in the break mode flag determination step S100; and a step S305 of displaying a mark B at the break point when it is determined that the break mode flag is other than 1 in the break mode flag determination step S100, and then terminates the break point display processing.

Next, an example of the break point display processing step S33 shall be explained. When the program debug device 2 performs the window focus processing step S21 on the source code written in the high level language, the break mode flag is set to 1 because the process for the high-level language source display window which is focused on is selected in the source focus determination step S203 within the break mode flag set processing step S11. When the break point is set by the break point set processing step S1, a conditional break is set for the break point. When the break point display processing step S33 is performed in this state, since the break mode flag is 1 in the break mode flag determination step S100, a mark A is displayed at the break point. Furthermore, when the window focus processing step S21 is performed on disassembly language, the break mode flag is set to 0 because the process to be performed for the case where the disassembly code display window is focused on is selected in the source focus determination step S203 within the break mode flag set processing step S11. When the break point display processing step S33 is performed in this state, since the process for the break mode flag which is 0 is selected in the break mode flag determination step S100, the mark B is displayed at the break point.

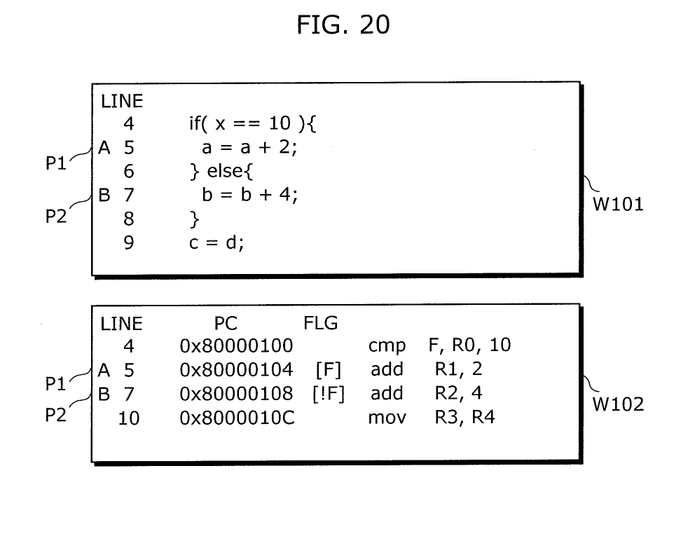

FIG. 20 is a diagram showing a display example of a source display window and an assembler display window. As shown in FIG. 20, the mark A is attached to the source code at the fifth line in the source display window W101 and the disassembly code at the fifth line in the disassembly code display window W102. The mark A indicates that the conditional break is set. Furthermore, the mark B is attached to the source code at the seventh line in the source display window W101 and the disassembly code at the seventh line in the disassembly code display window W102. The mark B indicates that the unconditional break is set.

According to the aforementioned configuration, the debug operator can visually recognize the type of the break point and omit the operation of verifying the type of the break point, thus reducing processing loads on the debug operator and improving efficiency in debug operations.

Whereas in the present embodiment, marks A and B are used for distinguishing the break points, other alphabets such as C and D, numeric such as 1 and 2, symbols such as □ and □, or the like may be similarly used.

Whereas in the present embodiment, marks A and B are used for distinguishing the break points, the marking may be replaced by coloring the background of the source code line at which the break point is set with colors such as blue and red, adding lines such as wave lines and straight lines above and blow the source code line at which the break point is set, enclosing the source code line at which the break point is set with various boxes of different widths, or the like.

### INDUSTRIAL APPLICABILITY

The debug device according to the present invention is suitable for the program debug device which supports program development of software developers by displaying an execution state of a program while arbitrarily executing and stopping the program. For example, it is suitable for a debug device which debugs a program including a predicated instruction at a source code level and the assembly code level such as C language.

1. A debug device which stops execution of a program based on one of an unconditional break for stopping the program regardless of a condition of a predicated instruction and a conditional break for stopping the program only when the condition of the predicated instruction is true, said debug device comprising:
a receiving unit operable to receive a break point according to an operation by a user;
a determination unit operable to determine the received break point as the unconditional break or the conditional break, according to a state of said debug device; and
a stop unit operable to stop the program based on the unconditional break or the conditional break determined by said determination unit.

2. The debug device according to claim 1,
wherein said determination unit is operable to judge, as the state of said debug device, whether or not a high-level language source code display window is focused on when said receiving unit receives the break point.

3. The debug device according to claim 2,
wherein said determination unit is operable to:
determine the break point as the conditional break upon judging that the source code display window is focused on; and
determine the break point as the unconditional break upon judging that the source code display window is not focused on.

4. The debug device according to claim 1,
wherein said determination unit is operable to judge, as the state of said debug device, whether or not a source code is displayed on a high-level language source code display window, when said receiving unit receives the break point.

5. The debug device according to claim 4,
wherein said determination unit is operable to:
determine the break point as the conditional break upon judging that the source code is displayed on the source code display window; and
determine the break point as the unconditional break upon judging that the source code is not displayed on the source code window.

6. The debug device according to claim 1,
wherein said determination unit is operable to judge, as the state of said debug device, whether or not a source code line is designated in a high-level language source code display window, when said receiving unit receives the break point.

7. The debug device according to claim 6,
wherein said determination unit is operable to:
determine the break point as the conditional break upon judging that the source code line is designated in the source code display window; and
determine the break point as the unconditional break upon judging that the source code line is not designated in the source code display window.

8. The debug device according to claim 1,
wherein said determination unit is operable to judge, as the state of said debug device, whether or not a high-level language source code display window is focused on, during the execution of the program.

9. The debug device according to claim 8,
wherein said determination unit is operable to:
determine the break point as the conditional break upon judging that the source code display window is focused on; and
determine the break point as the unconditional break upon judging that the source code display window is not focused on.

10. The debug device according to claim 1, further comprising
an attaching unit operable to attach a mark to a source code line or an assembler code line that is designated as the break point, the mark indicating a break point,
wherein the mark is different depending on whether the break point is the unconditional break or the conditional break.

11. A debug method for use in a debug device which stops execution of a program based on one of an unconditional break for stopping the program regardless of a condition of a predicated instruction or a conditional break for stopping only when the condition of the predicated instruction is true, said debug method comprising:
a receiving step of receiving a break point according to an operation by a user;
a determination step of determining the received break point as the unconditional break or the conditional break, according to a state of the debug device; and
a stopping step of stopping the program based on the unconditional break or the conditional break determined in said determination step.

12. A program executable by a processor which controls a debug device which stops execution of a program based on one of an unconditional break for stopping the program regardless of a condition of a predicated instruction and a conditional break for stopping only when the condition of the predicated instruction is true, said program causing the processor to execute:
a receiving step of receiving a break point according to an operation by a user;
a determination step of determining the received break point as the unconditional break or the conditional break, according to a state of the debug device; and
a stopping step of stopping the program based on the unconditional break or the conditional break determined in said determination step.
